(19) United States
(12) Patent Application Publication
(10) Pub. No.: US 2026/0291851 A1
(43) Pub. Date: Sep. 24, 2026

(54) INFORMATION PROCESSING SYSTEM

(71) Applicant: TOYOTA JIDOSHA KABUSHIKI KAISHA, Toyota-shi (JP)

(72) Inventor: Tsuneo NAKATA, Kamakura-shi (JP)

(73) Assignee: TOYOTA JIDOSHA KABUSHIKI KAISHA, Toyota-shi (JP)

(21) Appl. No.: 19/432,604

(22) Filed: Dec. 24, 2025

(30) Foreign Application Priority Data
Mar. 19, 2025 (JP) 2025-044859

(51) Int. Cl. H04L 45/122

(52) U.S. Cl. CPC H04L 45/122

(57) ABSTRACT

In an information processing system including a first node, a second node, and a third node, the first node calculates a first score for data transmission from the first node to the third node based on a rule stored in advance, and transmits the first score to the second node. The second node calculates a second score for data transmission from the second node to the third node based on the rule stored in advance, and transmits the second score to the first node. The first node transmits, in a case where a determination is made that the second score is lower than the first score, data having the third node as a destination to the second node. The second node transmits the data received from the first node to the third node.

### CROSS-REFERENCE TO RELATED APPLICATION

This application claims priority to Japanese Patent Application No. 2025-044859 filed on March 19, 2025. The disclosure of the above-identified application, including the specification, drawings, and claims, is incorporated by reference herein in its entirety.

### BACKGROUND

### 1. Technical Field

The present disclosure relates to an information processing system.

### 2. Description of Related Art

Japanese Unexamined Patent Application Publication No. 2009-218626 (JP 2009-218626 A) discloses a path multiplexing communication system in which, in a case where a transmission node transmits a path multiplexing request message to a relay node and the relay node replies to the transmission node with a path multiplexing response message, the transmission node transmits data to the relay node.

### SUMMARY

In the technology of JP 2009-218626 A, in a case where adjacent nodes transmit relay requests (path multiplexing request messages) to each other and both nodes permit the relay, unnecessary communication occurs between the nodes. As a result, since an unnecessary multi-hop path is generated, and the quality of end-to-end communication is also deteriorated, efficient communication cannot be performed.

In addition, since a permission criterion of the relay changes depending on an operation program or a setting implemented in each of the nodes, fairness between the nodes is not ensured, and the higher the permission criterion, the smaller a burden of the relay, so that efficient communication cannot be performed.

The present disclosure has been made in view of the circumstances, and an object thereof is to provide an information processing system that can enable more efficient communication between nodes.

An information processing system according to the present disclosure includes a first node, a second node, and a third node, in which

the first node is configured to

calculate a first score for data transmission from the first node to the third node based on a rule stored in advance, and

transmit the first score to the second node,

the second node is configured to

calculate a second score for data transmission from the second node to the third node based on the rule stored in advance, and

transmit the second score to the first node,

the first node is configured to transmit, in a case where a determination is made that the second score is lower than the first score, communication traffic to the third node as a packet having the third node as a destination to the second node, and

the second node is configured to transmit the packet received from the first node to the third node.

An information processing system according to the present disclosure includes a first node, a second node, and a third node, in which

the first node is configured to

calculate a first score for data transmission from the first node to the third node based on a rule stored in advance, and

transmit the first score to the second node,

the second node is configured to

calculate a second score for data transmission from the second node to the third node based on the rule stored in advance, and

transmit the second score to the first node,

the first node is configured to transmit, in a case where a determination is made that the second score is lower than the first score, data having the third node as a destination to the second node, and

the second node is configured to transmit the data received from the first node to the third node.

In the information processing system according to the present disclosure, the second node is configured to

calculate, in a case where the data is received from the first node, the second score for the data transmission from the second node to the third node based on the rule stored in advance, and

transmit, in the case where a determination is made that the second score is lower than the first score, the data to the third node.

In the information processing system according to the present disclosure, a communication link between the first node and the second node is a Wi-Fi communication.

In the information processing system according to the present disclosure, the first node and the second node are configured to calculate an amount of data that is waiting to be transmitted and that does not fall within a threshold value that is predetermined as the first score or the second score based on the rule stored in advance.

In each of the information processing system according to the present disclosure, a plurality of classes having different priorities of communication traffic, different queues, and the rule is defined in the first node, the second node, and the third node. The first node is configured to calculate the first score for each of the classes based on the rule stored in advance. The second node is configured to calculate the second score for each of the classes based on the rule stored in advance. The first node is configured to transmit, in the case where a determination is made that the second score is lower than the first score in a class having a higher priority, the data having the third node as the destination to the second node.

According to the present disclosure, it is possible to realize an information processing system that can enable more efficient communication between nodes.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an information processing system according to an embodiment;

FIG. 2 is a sequence diagram showing processing of the information processing system;

FIG. 3 is a schematic configuration diagram of an information processing system according to Embodiment 1;

FIG. 4 is a diagram showing the information processing system in a case where the second score is large; and

FIG. 5 is a schematic configuration diagram of an information processing system according to Embodiment 2.

### DETAILED DESCRIPTION OF EMBODIMENTS

The information processing system according to the embodiment of the present disclosure will be described with reference to the drawings. It should be noted that the components in the following embodiment include components that can be easily replaced by a person skilled in the art or components substantially the same.

### Embodiment

### Configuration of Information Processing System

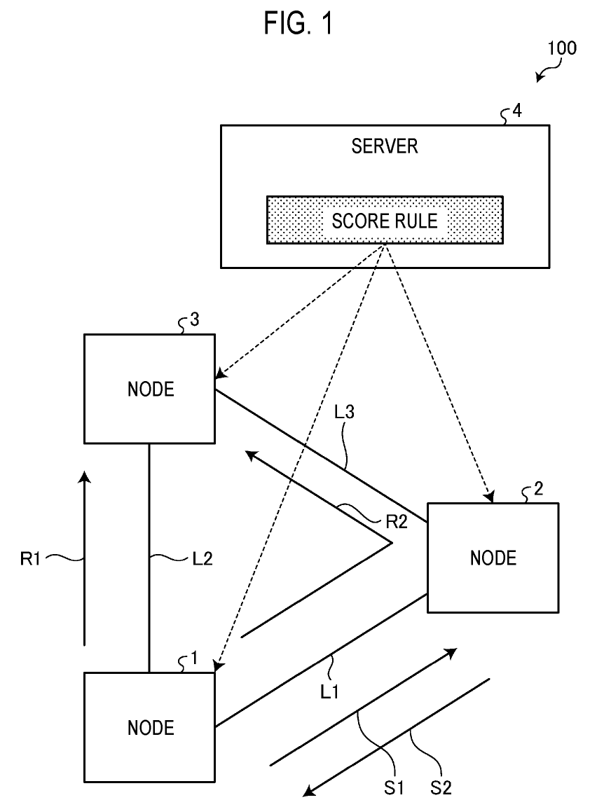

FIG. 1 is a schematic configuration diagram of an information processing system according to the embodiment. As shown in FIG. 1, an information processing system 100 includes a node 1, a node 2, a node 3, and a server 4.

The node 1, the node 2, the node 3, and the server 4 all have a communication function, and are configured to communicate with each other through a communication link and exchange various types of information. The communication link is configured by, for example, a public line network such as an Internet line network and a mobile phone line network, but may include wireless communication such as Wi-Fi (registered trademark, Wireless Fidelity) and Bluetooth (registered trademark) Low Energy (BLE), and a satellite line via a satellite.

The node 1 and the node 2 are, for example, a data communication module (DCM) including a processor consisting of a central processing unit (CPU) or the like and a memory consisting of a read only memory (ROM), a random access memory (RAM), or the like, but may be various terminals such as a smartphone and a personal computer. A communication link L1 between the node 1 and the node 2 is a Wi-Fi communication. In addition, communication links L2 and L3 between the node 1 and the node 2 and the node 3 are cellular lines.

The node 3 is realized by, for example, a general-purpose computer such as a workstation or a personal computer including a processor consisting of a CPU or the like and a memory consisting of a ROM, a RAM, or the like.

The server 4 is realized by, for example, a general-purpose computer such as a workstation or a personal computer including a processor consisting of a CPU or the like and a memory consisting of a ROM, a RAM, or the like. The server 4 generates a score rule that defines a rule for calculating the score, and delivers the score rule to the node 1, the node 2, and the node 3. It should be noted that the rule is not limited to the score rule for calculating the score, and may be a rule for calculating a rank or a priority. In addition, the rule may be stored in advance in the memory of each node.

### Processing of Information Processing System

Next, processing executed by the information processing system 100 will be described. Specifically, processing of transmitting data from the node 1 as the first node to the node 3 as the third node via the node 2 as the second node will be described.

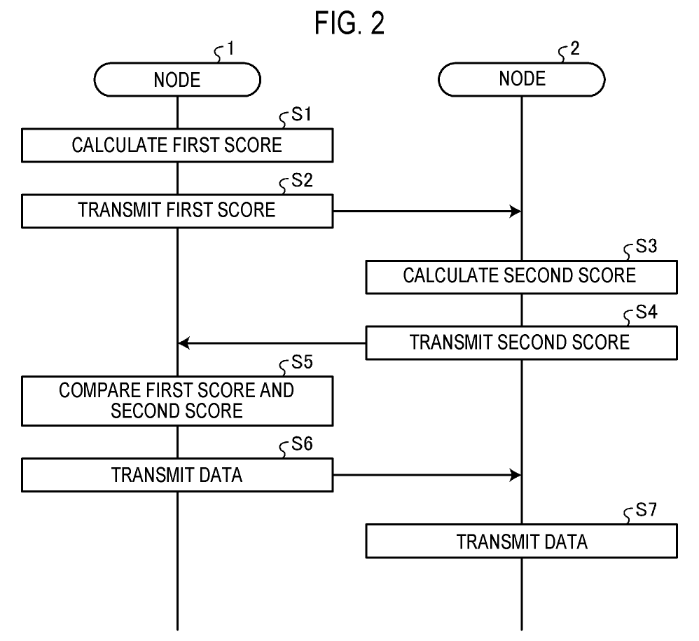

FIG. 2 is a sequence diagram showing the processing of the information processing system. As shown in FIG. 2, the node 1 calculates a first score SC1 for data transmission from the node 1 to the node 3 based on the score rule that is delivered from the server 4 in advance and stored in the memory (S1).

Subsequently, the node 1 transmits the calculated first score SC1 to the node 2 (S2).

In a case where the first score SC1 is received from the node 1, the node 2 calculates a second score SC2 for data transmission from the node 2 to the node 3 based on the score rule that is delivered from the server 4 in advance and stored in the memory (S3).

Further, the node 2 transmits the calculated second score SC2 to the node 1 (S4).

In a case where the second score SC2 is received from the node 2, the node 1 compares the first score SC1 and the second score SC2 (S5).

In a case where a determination is made that the second score SC2 is lower than the first score SC1, the node 1 transmits communication traffic to the node 3 as a packet having the node 3 as a destination to the node 2 (S6). It should be noted that, in a case where a determination is made that the second score SC2 is equal to or higher than the first score SC1, the node 1 can directly transmit the packet to the node 3, but cannot transmit the packet to the node 3 via the node 2. In this case, in a case where the node 2 is requested to relay the packet to the node 3, the node 1 transmits the packet to the node 3.

In a case where the data is received from the node 1, the node 2 transmits the packet received from the node 1 to the node 3 (S7). It should be noted that, in the case where the data is received from the node 1, the node 2 may calculate the second score SC2 for data transmission from the node 2 to the node 3 again based on the score rule. In the case where the determination is made that the calculated second score SC2 is lower than the first score SC1, the node 2 may transmit the data to the node 3.

According to the embodiment described above, the node 1 can use a path R2, which is a relay path of transmitting the data from the node 1 to the node 3 via the node 2, in addition to a path R1 of directly transmitting the data from the node 1 to the node 3. In the processing, the node 1, the node 2, and the node 3 calculate the score using the same score rule. Since only the relay from the node having a high score to the node having a low score is executed, unnecessary communication between the nodes is prevented, and more efficient communication between the nodes can be performed.

In addition, according to the embodiment, since the node 1, the node 2, and the node 3 calculate the score using the same score rule, the burden of the relay of each node is not biased, and more efficient communication between the nodes can be performed.

In addition, in the embodiment, the example has been described in which the node 1 transmits the first score to the node 2, and the node 2 that has received the first score transmits the second score to the node 1, but the present disclosure is not limited to the example. The node 1 and the node 2 may calculate the score again each time the relay communication is completed, and exchange the calculated score. In addition, in a case where a situation that affects the score is detected, the node 1 and the node 2 may calculate the score again and exchange the calculated score. The situation that affects the score is, for example, a slowdown of the communication link L2 or the communication link L3, or input of burst traffic. In addition, the node 1, the node 2, and the node 3 may calculate and transmit the score at periods that are predetermined, and each node may always hold the latest score of the adjacent node. In this case, the node having a high score can request the adjacent node having a low score to relay the data.

### Embodiment 1

### Configuration of Information Processing System

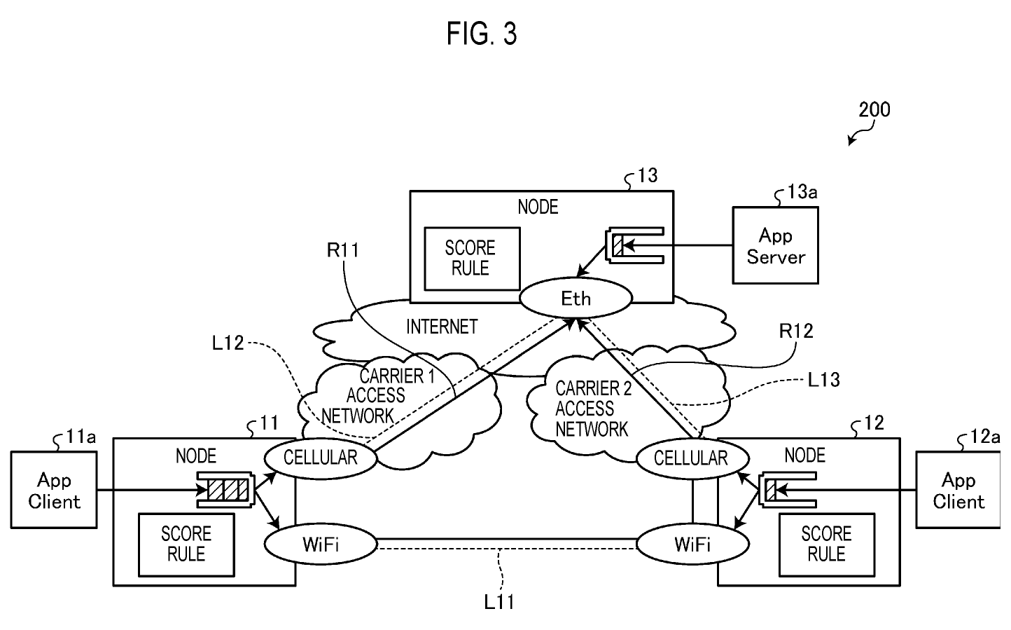

FIG. 3 is a schematic configuration diagram of an information processing system according to Embodiment 1. As shown in FIG. 3, an information processing system 200 includes a node 11, a node 12, and a node 13.

The node 11 and the node 12 are, for example, a data communication module (DCM) including a processor consisting of a CPU or the like and a memory consisting of a ROM, a RAM, or the like, but may be various terminals such as a smartphone and a personal computer. A communication link L11 between the node 11 and the node 12 is a Wi-Fi communication. In addition, communication links L12 and L13 between the node 11 and the node 12 and the node 13 are cellular lines.

The node 13 is realized by, for example, a server including a processor consisting of a CPU or the like and a memory consisting of a ROM, a RAM, or the like.

The memory of the node 11, the node 12, and the node 13 stores the same score rule in advance. In addition, in the queue of the node 11 and the node 12 that is waiting to be transmitted, data to be transmitted is accumulated from an app client 11a and an app client 12a, respectively. Similarly, in the queue of the node 13 that is waiting to be transmitted, data to be transmitted is accumulated from an app server 13a.

### Processing of Information Processing System

The node 11 and the node 12 detect that the node 11 and the node 12 are adjacent to each other by a communication link L11 that is a Wi-Fi communication by a beacon, a Hello message, or the like. Further, the node 11 and the node 12 include adjacent node information in the beacon or the Hello message. As a result, the node 11 detects that the node 12 can be connected to the node 13 via the communication link L13 that is a cellular line. Similarly, the node 12 detects that the node 11 can be connected to the node 13 via the communication link L12 that is a cellular line.

The node 11 and the node 12 calculate, based on the rule stored in advance in the memory, a data amount accumulated in the queue that is waiting to be transmitted and that does not fall within a threshold value that is predetermined as the first score or the second score. Specifically, the node 11 calculates the first score as a data amount of the node 11 that is waiting to be transmitted – (bandwidth estimation value of the communication link L12 × defined delay value). Similarly, the node 12 calculates the second score as a data amount of the node 12 that is waiting to be transmitted – (bandwidth estimation value of the communication link L13 × defined delay value).

In a case where the time until the end of the delivery of the data that is waiting to be transmitted approaches or exceeds the defined delay value due to the increase in the traffic, the node 11 and the node 12 request the adjacent node to relay the data to the node 13 in order to reduce the delay. Therefore, the node 11 and the node 12 transmit the calculated score.

It should be noted that the score rule may define a calculation expression of the relayable data amount. For example, the node 11 calculates the relayable data amount as (first score – second score) × default margin ratio. The default margin ratio is a value of 1 or less defined in advance.

In the state shown in FIG. 3, the data amount accumulated in the queue of the node 11 that is waiting to be transmitted is larger than the data amount accumulated in the queue of the node 12 that is waiting to be transmitted. That is, the second score is lower than the first score. Therefore, the node 11 can use a path R12, which is a relay path of transmitting the data from the node 11 to the node 13 via the node 12, in addition to a path R11 of directly transmitting the data from the node 11 to the node 13.

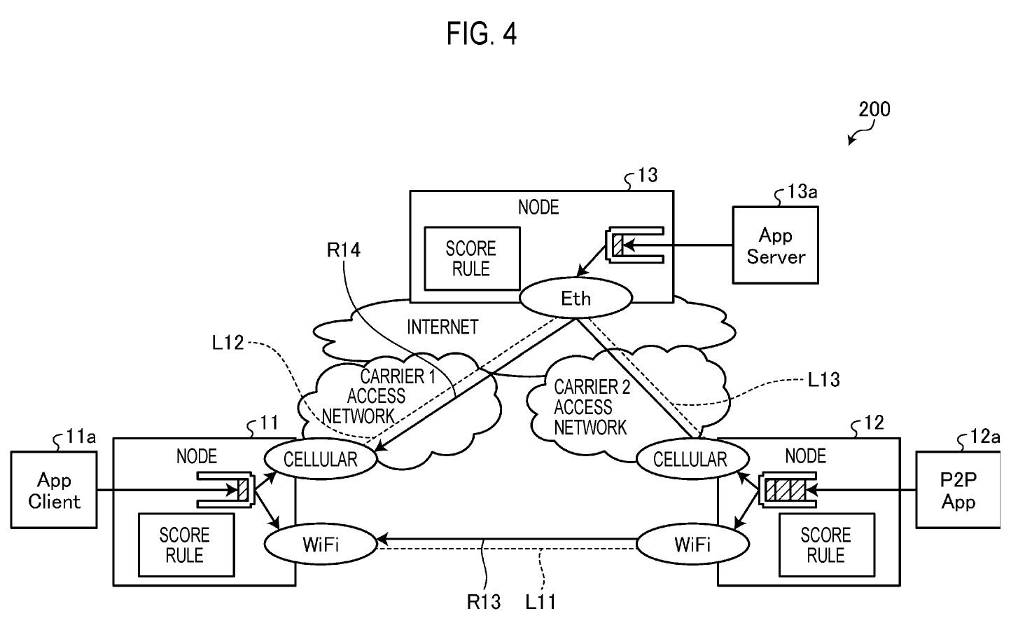

FIG. 4 is a diagram showing the information processing system in a case where the second score is large. In the state shown in FIG. 4, the data amount accumulated in the queue of the node 11 that is waiting to be transmitted is smaller than the data amount accumulated in the queue of the node 12 that is waiting to be transmitted. That is, the second score is higher than the first score. Therefore, the node 12 can use a relay path of transmitting the data from the node 12 to the node 13 via the node 11 in addition to a path of directly transmitting the data from the node 12 to the node 13.

In addition, in a case where the node 12 transmits the data to the node 11, as shown in FIG. 4, the node 12 can use a path R14, which is a relay path of transmitting the data from the node 12 to the node 11 via the node 13, in addition to a path R13 of directly transmitting the data from the node 12 to the node 11.

According to Embodiment 1 described above, in the pieces of processing, the node 11, the node 12, and the node 13 calculate the score using the same score rule. Since only the relay from the node having a high score to the node having a low score is executed, unnecessary communication between the nodes is prevented, and more efficient communication between the nodes can be performed.

In addition, according to Embodiment 1, since the node 11, the node 12, and the node 13 calculate the score using the same score rule, the burden of the relay of each node is not biased, and more efficient communication between the nodes can be performed.

It should be noted that, in a case where the communication link from the transmission node to the relay node and the communication link from the relay node to the destination node consume a common resource (for example, in a case where both communication links are Wi-Fi in the same frequency band), it is preferable that the bandwidth estimation value used for the score calculation is 1/2 of the bandwidth estimation value measured in a state where the relay is not performed. This is because two links of resources are consumed by the relay.

### Embodiment 2

### Configuration of Information Processing System

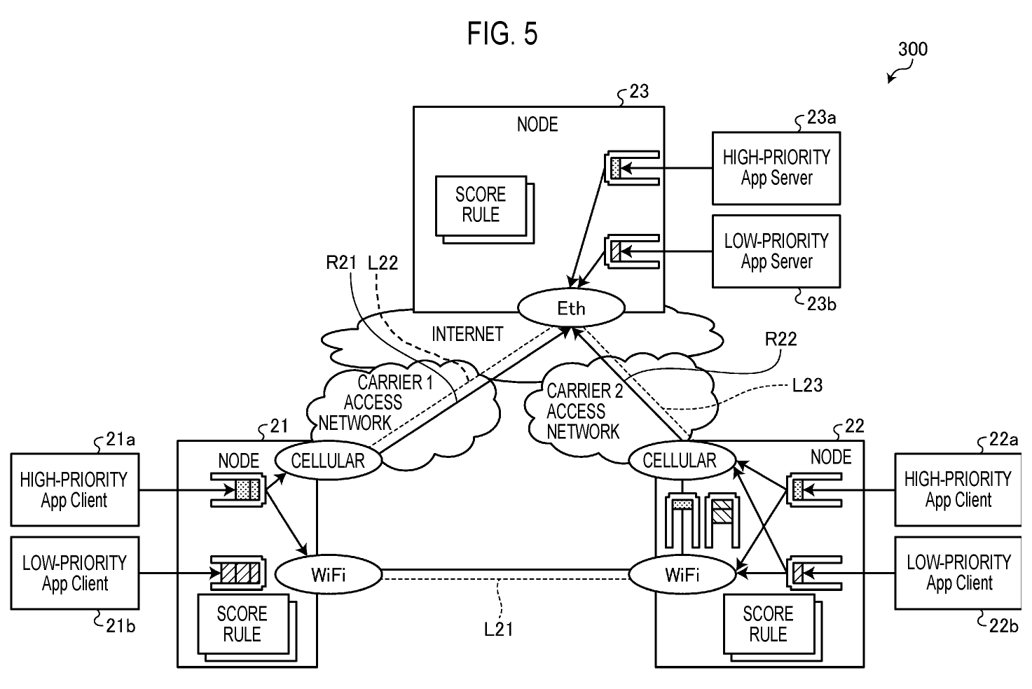

FIG. 5 is a schematic configuration diagram of an information processing system according to Embodiment 2. As shown in FIG. 5, an information processing system 300 includes a node 21, a node 22, and a node 23.

The node 21 and the node 22 are, for example, a data communication module (DCM) including a processor consisting of a CPU or the like and a memory consisting of a ROM, a RAM, or the like, but may be various terminals such as a smartphone and a personal computer. A communication link L21 between the node 21 and the node 22 is a Wi-Fi communication. In addition, communication links L22 and L23 between the node 21 and the node 22 and the node 23 are cellular lines.

The node 23 is realized by, for example, a server including a processor consisting of a CPU or the like and a memory consisting of a ROM, a RAM, or the like.

In the node 21, the node 22, and the node 23, a plurality of classes having different priorities of communication traffic, different queues, and the rule are defined. Here, an example will be described in which two classes of a high-priority class and a low-priority class are defined as the classes.

Specifically, the node 21, the node 22, and the node 23 have a high-priority queue and a low-priority queue. In addition, the memory of the node 21, the node 22, and the node 23 stores the same score rule in advance. The score rule calculates the score based on different rules for high-priority data and low-priority data.

In the high-priority queue of the node 21 and the high-priority queue of the node 22 that are waiting to be transmitted, data to be transmitted is accumulated from an app client 21a and an app client 22a, respectively. In the low-priority queue of the node 21 and the low-priority queue of the node 22 that are waiting to be transmitted, data to be transmitted is accumulated from an app client 21b and an app client 22b, respectively.

Similarly, in the high-priority queue of the node 23 that is waiting to be transmitted, data to be transmitted is accumulated from an app server 23a, and in the low-priority queue of the node 23 that is waiting to be transmitted, data to be transmitted is accumulated from an app server 23b.

### Processing of Information Processing System

The node 21 and the node 22 detect that the node 21 and the node 22 are adjacent to each other by a communication link L21 that is a Wi-Fi communication by a beacon, a Hello message, or the like. Further, the node 21 and the node 22 include adjacent node information in the beacon or the Hello message. As a result, the node 21 detects that the node 22 can be connected to the node 23 via the communication link L23 that is a cellular line. Similarly, the node 22 detects that the node 21 can be connected to the node 23 via the communication link L22 that is a cellular line.

The node 21 and the node 22 calculate, based on the score rule stored in advance in the memory, a data amount accumulated in the queue that is waiting to be transmitted and that does not fall within a threshold value that is predetermined as the first score or the second score. In addition, the node 21 calculates the first score for each class based on the score rule stored in advance in the memory, and the node 22 calculates the second score for each class based on the score rule stored in advance in the memory.

Specifically, the node 21 calculates the first score as (data amount of the node 21 that is waiting to be transmitted in a predetermined class of the node 21 + data amount of the node 21 that is waiting to be transmitted in a class of the node 21 having a higher priority than the predetermined class) – (bandwidth estimation value of the communication link L22 × defined delay value of the predetermined class of the node 21). Similarly, the node 22 calculates the second score as (data amount of the node 22 that is waiting to be transmitted in a predetermined class of the node 22 + data amount of the node 22 that is waiting to be transmitted in a class of the node 22 having a higher priority than the predetermined class) – (bandwidth estimation value of the communication link L23 × defined delay value of the predetermined class of the node 22).

In a case where the time until the end of the delivery of the data that is waiting to be transmitted approaches or exceeds the defined delay value due to the increase in the traffic, the node 21 and the node 22 transmit the calculated score in order to request the adjacent node to relay the data to the node 23 in order to reduce the delay.

It should be noted that the score rule may define a calculation expression of the relayable data amount. For example, the node 21 calculates the relayable data amount as (first score of the predetermined class of the node 21 – second score of the predetermined class of the node 22) × default margin ratio of the predetermined class. The default margin ratio is a value of 1 or less defined in advance for each class.

In a case where the determination is made that the second score is lower than the first score in a class having a higher priority, the node 21 transmits data having the node 23 as a destination to the node 22.

In the state shown in FIG. 5, the data amount accumulated in the high-priority queue of the node 21 that is waiting to be transmitted is larger than the data amount accumulated in the high-priority queue of the node 22 that is waiting to be transmitted. That is, the second score is lower than the first score. Therefore, the node 21 can use a path R22, which is a relay path of transmitting the data from the node 21 to the node 23 via the node 22, in addition to a path R21 of directly transmitting the data from the node 21 to the node 23.

According to Embodiment 2 described above, in the pieces of processing, the node 21, the node 22, and the node 23 calculate the score using the same score rule, and only the relay from the node having a high score to the node having a low score is executed. Therefore, unnecessary communication between the nodes is prevented, and more efficient communication between the nodes can be performed.

In addition, according to Embodiment 2, since the node 21, the node 22, and the node 23 calculate the score using the same score rule, the burden of the relay of each node is not biased, and more efficient communication between the nodes can be performed.

Further effects and modifications can be easily derived by a person skilled in the art. Therefore, a broader aspect of the present disclosure is represented and described as described above, and is not limited to the specific details and representative embodiments described above. Accordingly, various changes can be made without departing from the gist or scope of the general inventive concept defined by the appended claims and equivalent thereof.

What is claimed is:

1. An information processing system comprising:
a first node;
a second node; and
a third node, wherein:
the first node is configured to
calculate a first score for data transmission from the first node to the third node based on a rule stored in advance, and
transmit the first score to the second node;
the second node is configured to
calculate a second score for data transmission from the second node to the third node based on the rule stored in advance, and
transmit the second score to the first node;
the first node is configured to transmit, in a case where a determination is made that the second score is lower than the first score, communication traffic to the third node as a packet having the third node as a destination to the second node; and
the second node is configured to transmit the packet received from the first node to the third node.

2. An information processing system comprising:
a first node;
a second node; and
a third node, wherein:
the first node is configured to
calculate a first score for data transmission from the first node to the third node based on a rule stored in advance, and
transmit the first score to the second node;
the second node is configured to
calculate a second score for data transmission from the second node to the third node based on the rule stored in advance, and
transmit the second score to the first node;
the first node is configured to transmit, in a case where a determination is made that the second score is lower than the first score, data having the third node as a destination to the second node; and
the second node is configured to transmit the data received from the first node to the third node.

3. The information processing system according to claim 2, wherein the second node is configured to
calculate, in a case where the data is received from the first node, the second score for the data transmission from the second node to the third node based on the rule stored in advance, and
transmit, in the case where a determination is made that the second score is lower than the first score, the data to the third node.

4. The information processing system according to claim 2, wherein a communication link between the first node and the second node is a Wi-Fi communication.

5. The information processing system according to claim 2, wherein the first node and the second node are configured to calculate an amount of data that is waiting to be transmitted and that does not fall within a threshold value that is predetermined as the first score or the second score based on the rule stored in advance.

6. The information processing system according to claim 2, wherein:
in each of the first node, the second node, and the third node, a plurality of classes having different priorities of communication traffic, different queues, and the rule is defined;
the first node is configured to calculate the first score for each of the classes based on the rule stored in advance;
the second node is configured to calculate the second score for each of the classes based on the rule stored in advance; and
the first node is configured to transmit, in the case where a determination is made that the second score is lower than the first score in a class having a higher priority, the data having the third node as the destination to the second node.
